(19) United States
(12) Patent Application Publication
(10) Pub. No.: US 2025/0250738 A1
(43) Pub. Date: Aug. 7, 2025

(54) BIOBASED MICROPARTICLES FOR TEXTILE TREATMENT

(71) Applicant: HEIQ MATERIALS AG, Schlieren (CH)

(72) Inventors: Raquel Maria MAGALHÃES VAZ VIEIRA, Vila Chã (PT); Maria Susana REGO DINIS, Penafiel (PT); Ana Catarina GODINHO MOREIRA, Porto (PT); Isabel Maria DUQUE MARTINS, Maia (PT)

(73) Assignee: HEIQ MATERIALS AG, Schlieren (CH)

(21) Appl. No.: 18/855,892

(22) PCT Filed: Apr. 4, 2023
(86) PCT No.: PCT/EP2023/058756

§ 371 Date: Oct. 10, 2024

(30) Foreign Application Priority Data
Apr. 11, 2022 (EP) 22167655.4

(51) Int. Cl. D06M 16/00; A01N 25/34; A01N 31/04; A01N 31/06; A01N 35/06; A01N 37/20; A01N 43/08; A01N 43/16; A01N 43/40; A01N 63/20; A01N 65/06; A01N 65/12; A01N 65/22; A01N 65/36; A01N 65/44; A01N 65/48; D06M 13/184; D06M 15/03; D06M 101/06; D06M 101/32

(52) U.S. Cl. CPC D06M 16/00; A01N 25/34; A01N 31/04; A01N 31/06; A01N 35/06; A01N 37/20; A01N 43/08; A01N 43/16; A01N 43/40; A01N 63/20; A01N 65/06; A01N 65/12; A01N 65/22; A01N 65/36; A01N 65/44; A01N 65/48; D06M 13/184; D06M 15/03; D06M 2101/06; D06M 2101/32

(57) ABSTRACT

Method for producing a biobased microparticulate emulsion or dispersion for textile treatment and for, on said textile, forming at least in areas a porous film carrying an active, in particular for antibacterial, and/or antiviral and/or anti-allergenic textile treatment, wherein the method comprises the following steps in given order: a) mixing a chitosan solution essentially consisting of chitosan in aqueous lactic acid with an emulsion, suspension, dispersion or solution of the active in a hydrophobic solvent under formation of an emulsion, b) adding, if required, further lactic acid to said emulsion for reducing the pH to a value in the range of 3-4.2 and for initiating coacervation of said emulsion, c) adding a cross-linking agent for cross-linking of the droplets and/or particles in the emulsion or dispersion.

### TECHNICAL FIELD

The present invention relates to a method for producing microparticles comprising an active, in particular as an anti-allergenic or antiviral or antibacterial, for textile treatment. It furthermore relates to corresponding textile articles treated with such microparticles as well as uses of such microparticles.

### PRIOR ART

Bacterial, viral but also allergenic threats have become an increasing problem to the health of humans and animals. One way of avoiding these problems is by treatment of textiles by corresponding textile treatment formulations.

To find optimal textile treatment formulations remains a challenge, since on the one hand the corresponding treatment formulations need to be storage stable as treatment formulation but also as a corresponding layer on the textile, but on the other hand an active contained in the corresponding textile treatment formulation needs to be released under the appropriate circumstances. On the other hand the active should not be washed out too quickly in repeated washing cycles.

WO2010142401A1 relates to microcapsules for delivery of a liquid onto a surface such as a hard surface or a textile, such as mattress ticking. The microcapsules have a shell with an outer face and an inner face, the inner face encapsulating the liquid, and the liquid contains a microorganism such as a beneficial microorganism in a dormant state. The outer face of the microcapsules may comprise reactive functional groups whereby the outer face is chemically bondable, for instance covalently bondable to said surface. The microcapsules provide a beneficial microflora on said surface by rupture of the capsules deposited onto said surface to release the microorganism onto said surface. This may reduce or obviate the need for chemical antimicrobial agents to clean said surface. For surfaces, which are fabrics or textiles, rupture and release may occur during use of the fabric or textile.

Sharkawy et al (Ind. Eng. Chem. Res. 2017, 56, 5516-5526) report how fragrant and antimicrobial properties were conferred to cotton fabrics following microencapsulation using green materials. Limonene and vanillin microcapsules were produced by complex coacervation using chitosan/gum Arabic as shell materials and tannic acid as hardening agent. The effect of two emulsifiers; Span 85 and polyglycerol polyricinoleate (PGPR), on the encapsulation efficiency (EE %), microcapsule's size and morphology, and cumulative release profiles was studied. The mean diameter of the produced microcapsules ranged between 10.4 and 39.0 μm, whereas EE % was found to be between 90.4% and 100%. The use of Span 85 resulted in mononuclear morphology while PGPR gave rise to polynuclear structures, regardless of the core material (vanillin or limonene). The obtained microcapsules demonstrated a sustained release pattern; namely the total cumulative release of the active agents after 7 days at 37±1° C. was 75%, 52% and 19.4% for the polynuclear limonene microcapsules, the mononuclear limonene microcapsules and the polynuclear vanillin microcapsules, respectively. Grafting of the produced microcapsules onto cotton fabrics through an esterification reaction using citric acid as a nontoxic cross-linker followed by thermofixation and curing, was confirmed by SEM and FTIR spectroscopy. Standard antibacterial assays conducted on both microcapsules alone and impregnated onto the fabrics indicated a sustained antibacterial activity.

Valle et al. (Chitosan microcapsules: Methods of the production and use in the textile finishing, J Appl Polym Sci. 2021; 138:e50482) report that biopolymeric chitosan is considered a promising encapsulating agent for textile applications due to its biocompatibility, lack of toxicity, antibacterial activity, high availability, and low cost. After cellulose, it is nature's most important organic compound. Also, chitosan has unique chemical properties due to its cationic charge in solution. Microencapsulation technologies play an important role in protecting the trapped material and in the durability of the effect, controlling the release rate. The application of chitosan microcapsules in textiles follows the current interest of industries in functionalization technologies that give different properties to products, such as aroma finish, insect repellency, antimicrobial activity, and thermal comfort. In this sense, methods of coacervation, ionic gelation, and LBL are presented for the production of chitosan-based microcapsules and methods of textile finishing that incorporate them are presented, bath exhaustion, filling, dry drying cure, spraying, immersion, and grafting chemical. Finally, current trends in the textile market are identified and guidance on future developments.

### SUMMARY OF THE INVENTION

It is an object of the present invention to provide for new and improved textile treatment formulations with in particular antibacterial, antiviral and/or anti-allergenic effects, as well as to provide for methods for producing such formulations, and for textiles treated with such formulations.

According to a first aspect of the present invention, it relates to a method for producing an emulsion or dispersion for textile treatment and for, on said textile, forming at least in areas a porous film carrying an active, in particular for antibacterial, antiviral and/or anti-allergenic textile treatment. Typically the droplets and/or particles in the emulsion are microparticulate.

According to the first aspect, the proposed method comprises the following steps in given order:
a) mixing a chitosan solution, essentially consisting of chitosan in aqueous lactic acid (preferably exclusively consisting of chitosan in aqueous lactic acid), with an emulsion, dispersion, suspension or solution of the active in a hydrophobic solvent under formation of an emulsion,
b) adding, if required (not required if the emulsion obtained in step a is already at a pH in the range of 3-4.2), further lactic acid to said emulsion for reducing the pH to a value in the range of 3-4.2 and for initiating coacervation of said emulsion,
c) adding a cross-linking agent for cross-linking of the droplets and/or particles in the emulsion or dispersion.

As will be evidenced experimentally in the experimental section, using chitosan in lactic acid provides for unexpected advantages in terms of starting material stability, in terms of odour, colour as well as antimicrobial activity, specifically when compared with the situation of chitosan in acetic acid. All these effects individually or in combination contribute to the inventiveness of the present process relative to the prior art.

According to a first preferred embodiment of that first aspect of the present invention, the chitosan in the chitosan solution used in step a) has a molecular weight in the range of 200-500 g/mol, preferably in the range of 200-350 g/mol, most preferably in the range of 250-300 g/mol.

According to yet another preferred embodiment, the chitosan in the chitosan solution used in step a) has a degree of the deacetylation in the range of 90-99%, preferably in the range of 92-97%.

It is typically advantageous if the chitosan is present in the chitosan solution in step a) in a concentration in the range of 4-10% % w/w, preferably in the range of 5-8% w/w, most preferably in the range of 4-7% w/w.

Preferably, lactic acid is present in the chitosan solution used in step a) in a concentration in the range of 1.5-5% w/w, preferably in the range of 2-4.5% w/w, most preferably in the range of 3-4% w/w.

It is further preferred if the pH of the solution used in step a) is in the range of 3-5, preferably in the range of 3.5-4.2.

According to yet another preferred embodiment of the first aspect of the invention, the chitosan solution used in step a) has a viscosity in the range of 1500-3500 cP, preferably in the range of 2000-3000 cP, measured at 25° C.

As pointed out above, the chitosan solution essentially consists of chitosan, water and lactic acid. However in minor proportions of less than 0.5% w/w the chitosan solution may comprise processing and/or stabilization additives. In line with this, according to a preferred embodiment, the chitosan solution used in step a) further comprises at least one stabilizer, preferably in the form of zinc chloride and sodium sulfite or both, in an amount of less than 0.5% w/w, preferably of less than 0.3% w/w or less than 0.25% w/w. Preferably the at least one stabilizer, if present, is so in an amount of at least 0.05% w/w, of at least 0.1% w/w or 0.15% w/w.

Preferably, the chitosan which is used for preparing the chitosan solution is based on crustacean waste material, however chitosan derived from non-marine sources may be used as an alternative.

Preferably at least one of steps a)-c), preferably all steps a)-c), are carried out at a temperature in the range of 15-30° C., preferably in the range of 18-25° C. Indeed it is one of the prominent advantages of the present invention that the proposed composition of the chitosan solution and of the emulsion, suspension or solution of the active or chosen such that the manufacturing can take place essentially at room temperature.

Preferably, in step a) before joining the chitosan solution and the active, an emulsifier is added, preferably to the chitosan solution, wherein preferably the emulsifier is an emulsifier based on glycerol and/or fatty acids. Preferably the emulsifier is selected as polyglycerol polyricinoleate (preferably in which the polyglycerol moiety is made up by at least 75% w/w di-, tri- and tetraglycerols and at most 10% for heptaglycerol or higher, and/or with a viscosity of 14000 cP and/or having an acid value of max. 3.5 mg KOH/g and a hydroxyl value in the range of 70-110 mg KOH/g, a saponification value in the range of 170-210 mg KOH/g), glycerol monooleate, glyceryl dicaprylate, glyceryl dimyristate, glyceryl dioleate, glyceryl distearate, glyceryl monomyristate, glyceryl monooctanoate, glyceryl monooleate, glyceryl monostearate, glyceryl stearate, lecithin, polyglyceryl oleate, polyglyceryl stearate, tetraglyceryl monooleate, or a combination thereof. Typically the emulsifier is added to lead to a concentration, based on the weight of the chitosan solution and the emulsifier, in the range of 0.4-4% w/w, preferably in the range of 0.5-3% w/w, further preferably in the range of 0.6-2.5% w/w.

According to a preferred embodiment, the active is dissolved or suspended in at least one natural oil, preferably selected from the group consisting of oat oil, castor oil, coconut oil, almond oil, cod-liver oil, fish oil, cottonseed oil, rapeseed oil, soybean oil, linseed oil, palm oil, wheat germ oil, rice bran oil, olive oil, avocado oil, argan oil, blueberry seed oil, carrot seed oil, hazelnut oil, jojoba oil, quinoa oil, sesame oil, walnut oil, algae oil, acai oil, shea butter, mango butter, cocoa butter, or hydrogenated oils made therefrom, or a combination thereof.

Preferably, the active is present in the natural oil in the system to be added to the chitosan solution in a proportion of 5-60% w/w, preferably in the range of 10-50% w/w. Typically, in step a) the chitosan solution is added to the emulsion, suspension or solution of the active in a hydrophobic solvent such that in the joined emulsion, the emulsion, suspension, dispersion or solution of the active in a hydrophobic solvent is present in a proportion of 1-12% w/w, preferably in the range of 2-9% w/w.

According to a preferred embodiment, the active is selected from the group consisting of microorganisms, essential oils, fragrances, vitamins, prebiotics, or a combination thereof. The most preferred option for the active is to choose them as microorganisms. Typically, these microorganisms are carried in at least one of a carrier and nutrients, preferably in at least one of calcium carbonate (as carrier) and carbohydrates, preferably prebiotics. The calcium carbonate and/or nutrients (preferably carbohydrates), in particular prebiotics, preferably make up at least 90% w/w and the microorganisms make up at most 10% w/w (basically this is the composition of the active when added to the corresponding natural oil for preparing the system to be added to the chitosan solution). The mass proportion of the nutrients (preferably in the form of prebiotics) is preferably in the range of 5% to 20% of the mass of microorganisms, most preferably in the range of 10%±2% w/w.

Prebiotics in this context are defined as compounds which are non-digestible and resistant to breakdown by stomach acid and enzymes in the human gastrointestinal tract, are fermented by microorganisms on or in the body, and are stimulating the growth and activity of beneficial bacteria. Possible nutrients/prebiotics are fructans and galactans, resistant starch, pectin, beta-glucans, and xylooligosaccharides, inulin, soybean oligosaccharides, pectin-derived oligosaccharides, cocoa-derived flavanols, fructooligosaccarides or combinations thereof.

Preferably, the active is a dormant and/or non-pathogenic microorganism, preferably a mixture of different such microorganisms, preferably selected from the group consisting of Subtilis, Pumilus, Megaterium, Licheniformis, Amyloliquefaciens, Cereus, Anthracis, Licheniformis, Larvae, Lentimorbus, Popilliae, Sphaericus, Thuringiensis, Alvei, Brevis, Circulans, Coagulans, Macerans, or a combination thereof. Also, prebiotics can be selected and added to the formulation from a group of inulin, beta-glucan, soybean oligosaccharides, pectin and pectin-derived oligosaccharides, cocoa-derived flavanols, fructooligosaccarides.

The essential oils, fragrances and/or vitamins can be selected from the group of bergamot oil, lavender oil, peppermint oil, cedarwood oil, citronella oil, cardamon oil, cinnamon bark oil, clove oil, eucalyptus oil, geranium oil, ginger oil, lemon myrtle oil, lemongrass oil, rosemary oil, sandalwood oil, spearmint oil, tea tree oil, thyme oil, rose oil, orange oil, grapefruit oil, chamomile oil, wintergreen oil, vitamin A, Vitamin B3, vitamin B5, vitamin C, vitamin D, vitamin E, vitamin K, or a combination thereof.

According to yet another preferred embodiment, the droplets and/or particles in the emulsion or dispersion obtained in step c) have diameters in the range of 0.2-3 micrometres, preferably in the range of 0.7-2.5 micrometres.

The droplets and/or particles in the emulsion or dispersion obtained in step c) preferably consist of porous microparticles of the active embedded in a porous film or shell of cross-linked chitosan. Upon application of the corresponding system to a textile this particle/droplets structure is converted into a porous film of cross-linked chitosan which is adhering to the textile surface without the need of chemical attachment moieties, and in which porous microparticles of the active, typically microorganisms carried in calcium carbonate, are embedded.

Preferably, in step c) tannic acid is added as a cross-linking agent, however other cross-linking agents may include humic acid, gallic acid, genipin, sinapinic acid.

According to a preferred embodiment as concerns step c), in step c) a cross-linking agent preferably tannic acid, is added in a proportion, with respect to the total to which the cross-linking agent is added, in the range of 0.001-0.1% w/w, preferably in the range of 0.005-0.07% w/w.

Subsequent to step c), the porous microparticles or droplets obtained can be and typically are, preferably after drying, formulated into a textile treatment system, or a concentrate of such a system, wherein preferably that system is based on water only in addition to the dispersion obtained in step c).

The textile treatment system can be applied to fibers, yarn, or woven or nonwoven textiles, which are preferably further converted into clothing, household textiles, including furniture textiles.

Preferably the textile treatment system is added in a proportion of 3-15% weight of fabric, preferably in a proportion of 6-10% weight of fabric.

According to a second aspect of the present invention, it relates to a textile treatment system with a porous chitosan matrix in which porous particles of an active are embedded, preferably on an aqueous dispersion, emulsion or solution basis, obtainable or obtained using a method as given above.

According to yet another aspect of the present invention, it relates to a fiber, yarn or woven or nonwoven textile treated with a textile treatment system as detailed above and preferably obtained using a method as detailed further above, wherein preferably at least in areas there is a film of porous cross-linked chitosan with embedded porous microparticles of the active.

According to a further aspect of the present invention, it relates to clothing, household textile, including furniture textiles based on a fiber, yarn, or woven or nonwoven textile as detailed above, preferably produced using a method as detailed further above.

Last but not least and according to yet one further aspect of the present invention, it relates to the use of porous microparticles or droplets obtained using a method as detailed above for antibacterial and/or antiviral and/or anti-allergenic treatment of fibers, yarns or woven or nonwoven textile, in particular for clothing, household textiles, including furniture textiles. Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows volume size distribution of porous chitosan solution with porous particles embedded for two runs;

FIG. 2 shows SEM images of porous particles in a porous chitosan film, shown is the film obtained after solid content analysis (drying of formulation at 105° C. to remove water from the sample);

FIG. 3 shows SEM images of spores on textiles (microorganisms entrapped in chitosan film) and fibres coated by porous chitosan film, wherein in a) microorganisms as the active embedded in the porous chitosan film in a polyester knit fabric are shown, in b) and c) microorganisms as the active embedded into the porous chitosan film in a 100% cotton woven fabric, d) a porous chitosan film coated on 100% polyester knit fabric and e) a porous chitosan film between fibres on polyester/viscose blend knit fabric;

FIG. 4 comparison of colour stability of chitosan in acetic acid (Ch/AcAc) compared with chitosan in lactic acid (Ch/LacAc) when produced and kept at room temperature in a), after storage at 40° C. for 30 days in b), and after 5 days at 60° C. in c).

### DESCRIPTION OF PREFERRED EMBODIMENTS

As pointed out above, the manufacturing of the microparticulate emulsion or dispersion for textile treatment and for, on said textile, forming at least in areas a porous film carrying an active, in particular for antibacterial, antiviral and/or anti-allergenic textile treatment, involves the preparation of a chitosan solution. In that chitosan solution in the present experimental section the concentration of chitosan, in each case weight by weight, w/w, is concentration: 6%. The chitosan is a high molecular weight chitosan with a degree of deacetylation of approximately 95%. High molecular weight in this context means the molecular weight of the chitosan is in the range of 250-300 g/mol. The pH of the chitosan solution is normally in the range of 3.7-4.0, and the viscosity is in a range of 2000-3000 cP (measured according to ISO 2555 Plastics—Resins in the liquid state or in emulsions or dispersions Determination of apparent viscosity by Brookfield method), at a temperature of 25° C. by spindle 63, 20 rpm, Brookfield DVE viscosimeter. The chitosan solution is a mixture of lactic acid, water and chitosan, with the following proportions (w/w): Chitosan 6%, lactic acid 3.39%, water 90.4%. A zinc chloride and sodium sulfite residual amounts is added to stabilize the product, typically in an amount of 0.21% w/w.

As also pointed out above, the manufacturing of the micro-particulate emulsion or dispersion involves the preparation of a solution/emulsion/dispersion of the active in a natural oil. Typically the active is chosen to be probiotics, which are carried in calcium carbonate and prebiotics. Normally there is 90% w/w of carbonate calcium carrier and s 10% of Bacillus ferment in the starting material used for the preparation of that active system. Preferably the probiotics component is a mixture of different species, for example different species of Bacillus: subtilis, pumilus, megaterium, licheniformis, amyloliquefaciens.

Other species of Bacillus can be added such as cereus, anthracis, licheniformis, anthracis, larvae, lentimorbus, popilliae, sphaericus, thuringiensis, alvei, brevis, circulans, coagulans, macerans, etc.

Prebiotics can be optionally added to the formulation from a group of potential nutrients of inulin, Beta-glucan, soybean oligosaccharides, pectin and pectin-derived oligosaccharides, cocoa-derived flavanols, fructooligosaccarides.

Experimentally, the porous particles entrapped in the porous chitosan film are obtained e.g. by a process of coacervation. Firstly, the core solution with the active is prepared at room temperature, mixing the carrier oil and the active ingredient at moderate stirring. Active ingredient can be essential oils, microorganisms, skin care compounds, etc. The active ingredient can be present in the carrier oil in a proportion between 11%-48% w/w. For the biopolymer, i.e. chitosan phase, in a recipient the chitosan solution is provided and mixed with polyglycerol polyricinoleate (PGPR). The PGPR came from a lipid source of castor oil, polyglycerol moiety is 75%, minimum, for di-, tri- and tetraglycerols and 10%, maximum, for heptaglycerol or higher, with a viscosity of 14000 cP. In total mass, the chitosan solution should be between 90-96% and PGPR should be between 0.7-2% (weight/weight).

The core solution is added to the biopolymer phase, and the emulsification is achieved using a high-performance dispersing instrument, model T25 digital ULTRA-TURRAX® by IKA coupled with a dispersing tool, model S25N-25G. The motor rating input is 800 W and the speed range is 3000-25000 rpm. The dispersing tool is a rotor-stator type and has a stator diameter of 25 mm and a rotor diameter of 17 mm, enabling a production of emulsions with an ultimate finesse in the range of 1-10 μm. For 1 kg of product, velocity should be 11000-12000 rpm for 5 minutes. The pH of the emulsion is adjusted to 4.0, if required, by adding lactic acid. The emulsion is kept under moderate stirring (250-300 rpm) for 3 h, to ensure the reticulation of active ingredients into the chitosan film. The crosslinking step is achieved by adding dropwise a tannic acid aqueous solution (typically 0.35% w/w). In total mass of product, tannic acid should be in the range of 0.005-0.05% (w/w). After 3 h of continuous moderate stirring, the product is collected.

Final specifications of the product are:

| | |
|---|---|
| pH range | 4.0 ± 0.2 |
| Viscosity | 1500-3000 Cp* measured by spindle 63, 20 rpm, |
| | Brookfield DVE viscosimeter. |
| Solid content | 11-17% |
| Appearance | Light grey viscous liquid |

*Final Viscosity depends on chitosan initial viscosity and the active material entrapped in the matrix

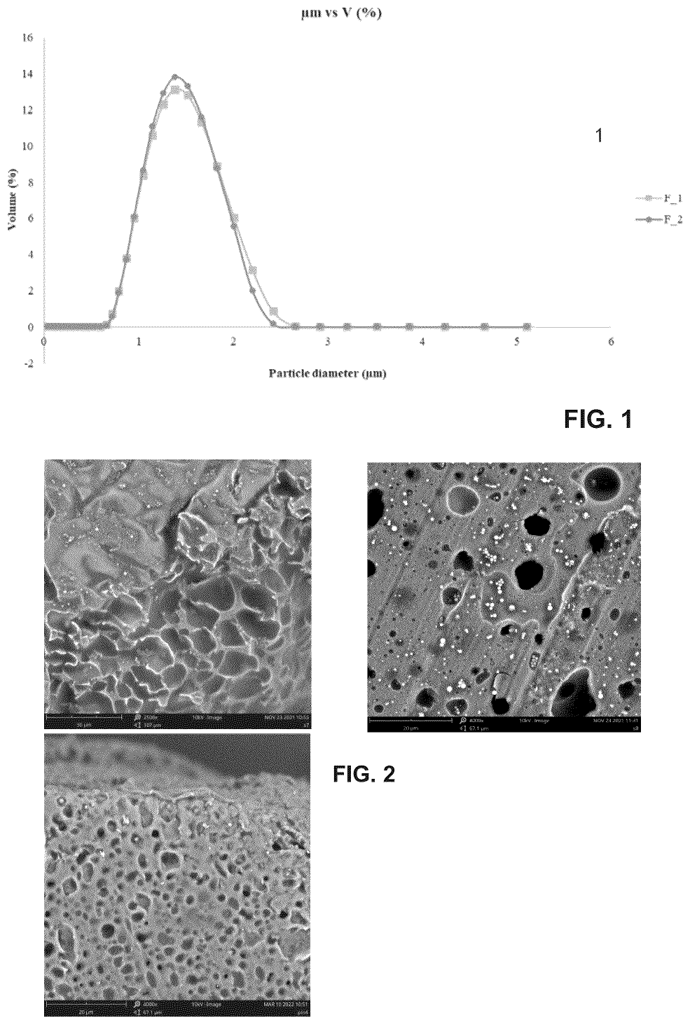

In this formulation, porous particles are embedded in the chitosan matrix. Particles have diameters around 1-2 μm, characterized by the volume size distribution, using a Laser Diffraction Particle Size Analyser LS230 by Beckman Coulter based on the laser diffraction technology (Polarization Intensity Differential Scattering, PIDS method, and light scattering theories of Mie and Fraunhofer, see FIG. 1). Formulation is dispersed in a medium of water (refraction index of 1.33) at room temperature of 20° C. Mean diameter is 1.5 μm. SEM images are obtained using a Phenom ProX desktop. A piece of chitosan porous film containing particles, obtained after solid content measurement (where water is removed) was put on the pin where previously a carbon tape was placed. SEM images were acquired within a resolution of ×2500 and ×4000 with an intensity of 10 kV. SEM images. FIG. 2 shows the entrapped porous microparticles into porous film of chitosan. Porosity of the material was measured by a Poremaster from Quantachrome, where a penetrometer with the sample is filled with mercury, in a vacuum chamber. Sample porosity is achieved by the penetration of mercury into the pores by different pressures. Porosity of the raw material (chitosan) is 42%. Porosity of the formulation (chitosan solution containing carrier oil and active ingredients) is around 4%. The reduction of porosity proves the reticulation of actives and carrier into the chitosan film, showing good entrapment.

For a non-washable items, for the treatment of textiles the impregnation bath can be prepared containing water and formulation, only. The application of formulation can be varied between 6-10% weight of fabric (w.o.f.). Drying is conducted at standard conditions (120-130° C.). For washable items, the impregnation bath is prepared containing water, formulation (5-10% w.o.f.), and a biobased polyurethane binder (0.3-4% w.o.f). A hydrophilicity agent (1.5% w.o.f.) can be added, to keep good hand feel and hydrophilicity of the fabrics. Dry at standard conditions (140° C.). pH of impregnation bath is maintained at approximately 4.

The shelf life of conventional formulations was very limited, being only days or weeks, there is sedimentation and degradation as well as film formation at the air to liquid interface. In particular phase separation and sedimentation of Arabic gum was observed. Fungi production in the top layer was also observed one week after production, at room temperature.

With this formulation as presented here, product remains stable for months at room temperature or even at elevated temperature (40° C.) without any adverse effects.

In addition, microorganisms entrapped into the porous film remain viable after 3 months following textile application. Microorganism counts on a polyester knit fabric (5.5% w.o.f.) demonstrates the formulation's stability on the treated textile as follows:

| Trial | CFU/g | log |
|---|---|---|
| After aplication | 1.66E+06 | 6.22 |
| after 1 month | 4.95E+05 | 5.69 |
| after 2 months | 7.94E+05 | 5.90 |
| after 3 months | 6.32E+05 | 5.80 |

The porous membrane acts as a protect layer for the active ingredients. An example is given by comparing the allergen reduction of samples applied with coated and uncoated microorganisms. Lower porosity of porous membrane leads to high retention and protection of microorganisms over the time as observed in the following table.

| Sample | | % reduction |
|---|---|---|
| Uncoated microorganisms | after application | 86.8 |
| | after 1 month | 44.8 |
| Coated microorganisms | after application | 96.6 |
| | after 1 month | 82.5 |

For the proposed formulation there is also less noticeable acid smell due to the use of lactic acid rather than acetic acid. Furthermore, the shelf life can be increased by using lactic acid instead of acetic acid. Literature reports lactic acid with a potential antimicrobial and antifungal activity. The lactic acid bacteria were also used as a natural bio-preservatives of food and feed in order to extend the shelf life of products. In the proposed approach here, the presence of lactic acid is primarily to dissolve chitosan, yet also helps to achieve a stable formulated product over time, avoiding the growth of fungi. Thus, lactic acid helps the stabilization not only the chitosan solution but also the chitosan porous solution with porous particles embedded (formulation).

For SEM analysis of textiles, a piece of a textile sample was cut and put on the pin where previously a carbon tape was placed. SEM images are obtained within a resolution range from ×1500 to ×7000 with an intensity of 10 kV.

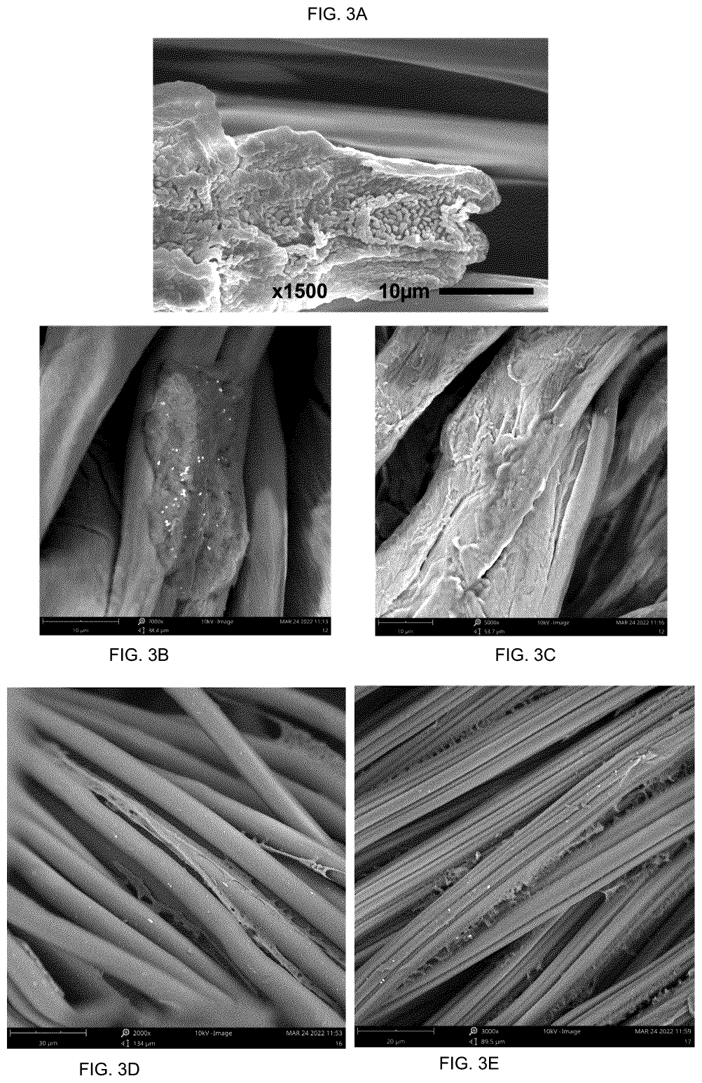

FIG. 3 illustrates the situation after application of the formulation to textile fibres. One can clearly see the porous chitosan film in which the active, in this case the microorganisms, is embedded in polyester knit fabric (FIG. 3-1) and 100% cotton woven fabric (FIGS. 3-2 and 3-3), there is no need to fracture mechanically to release the microorganisms, and surprisingly inspired of the porosity of the matrix based on chitosan there is nevertheless the higher stability and availability of the microorganisms. Figures d) and e) show the porous chitosan film coated on 100% polyester knit fabric and on polyester/viscose blend knit respectively. The coating is presented between fibers, and its porous appearance is similar to FIG. 2, where a porous film is observed.

In a further experimental series a comparison of solutions of chitosan in acetic acid and of chitosan in lactic acid was carried out.

### Storage Stability and Properties: Solutions of Chitosan in Acetic or Lactic Acid

Solutions of 6% wt of chitosan in lactic and acetic acid were submitted to different temperatures and different times:
Room temperature (22° C.) after 20 days of storage;
5° C. after 20 days of storage;
40° C. after 20 days of storage;
60° C. after 5 days of storage (extreme conditions)

### Viscosity Stability

Obtained values of viscosity for different temperatures for solutions of Chitosan in acetic acid or lactic acid:

| | Viscosity (cP) [% change compared to Initial] | | | | | | | |
|---|---|---|---|---|---|---|---|---|
| | Storage temperature | | | | | | | |
| | Room Temperature | | 5° C. | | 40° C. | | 60° C. | |
| | Acetic | Lactic | Acetic | Lactic | Acetic | Lactic | Acetic | Lactic |
| Days | acid | acid | acid | acid | acid | acid | acid | acid |
| 0 | 714 | 1086 | 714 | 1086 | 714 | 1086 | 714 | 1086 |
| (initial) | [0%] | [0%] | [0%] | [0%] | [0%] | [0%] | [0%] | [0%] |
| 5 | 702 | 1110 | — | — | — | — | 332 | 702 |
| | [−2%] | [2%] | | | | | [−54%] | [−35%] |
| 20 | 738 | 1092 | 708 | 1050 | 673 | 726 | — | — |
| | [3%] | [1%] | [−1%] | [−3%] | [−6%] | [−33%] | | |

At room temperature and for 5° C. after 5 and 20 days, viscosities of Chitosan in acetic acid and lactic acid remain very similar to the initial values. No significant variations were observed.

For storage temperature of 40° C., after 20 days, a decrease of viscosity is observed regardless of the acid type. Reduction of viscosity is slightly more pronounced in solution of chitosan in lactic acid (33%) compared to the solution of chitosan in acetic acid (6%).

For storage over 5 days at extreme temperature of 60° C., different behaviour on viscosities is observed. Decrease in viscosity of the solutions at 60° C. is observed for both chitosan in lactic acid and chitosan in acetic acid. The decrease of viscosity in chitosan in acetic acid is more evident, showing a reduction of 55% of the initial value, comparing to the viscosity of the chitosan in lactic acid, which shows a low reduction of 35% of the initial value.

### Odor Differences

Odor was assessed through qualitative assessment.

The smell of the chitosan in acetic acid is strong.

Chitosan in lactic acid has no smell.

### Color Stability

Color of the chitosan in acetic acid is more yellow than chitosan in lactic acid.

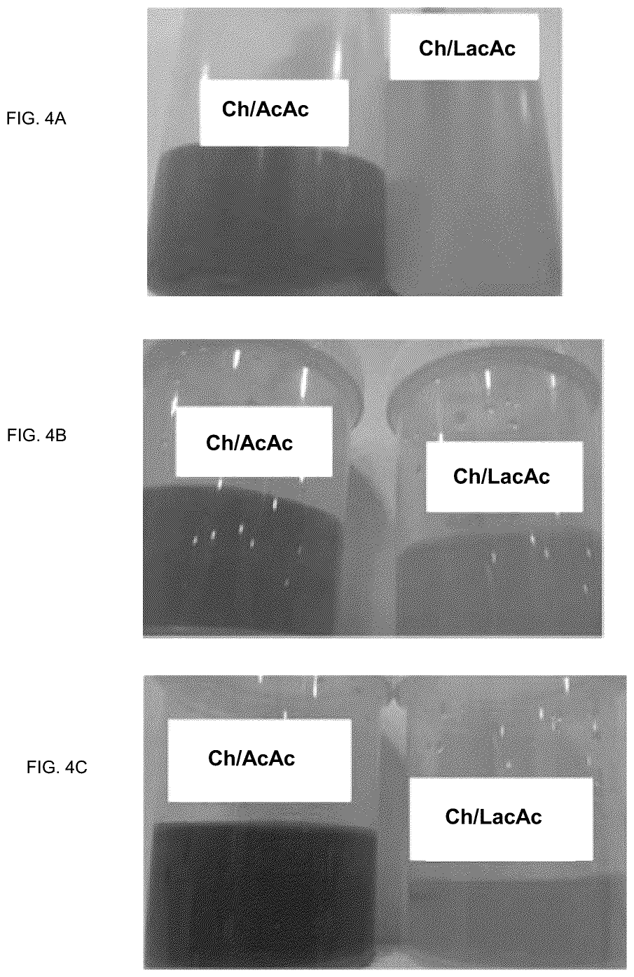

The level of color intensity increases with prolonged storage. After storage at 40° C. (30 days) and 60° C. (5 days) the yellow colour is intensified to near brown, see FIG. 4.

### Antimicrobial Effect Data

Solutions of 6% w/w chitosan in acetic acid and 6% w/w chitosan in lactic acid were applied on a 100% cotton substrate (woven; 118 g/m2).

Application was made using a laboratory padder (Rapid; 2.5 rpm; 3 bar) adjusted for pickup.

Drying was made in a lab stenter (Rapid; 120° C.; 3 mins).

The percentage of weight of fabric applied of each solution was adjusted to obtain the same applied mass concentration of lactic and acetic acid.

| Sample ID | Description | % wt of fabric |
|---|---|---|
| Sample 2 | Chitosan in acetic acid | 7.64 |
| Sample 4 | Chitosan in lactic acid | 10.70 |

Antimicrobial testing was performed according to ASTM E2149 (“Determining the Antimicrobial Activity of Immobilized Antimicrobial Agents Under Dynamic Contact Conditions”) with Staphylococcus aureus (ATCC 6538P).

| | Sample 2 | Sample 4 |
|---|---|---|
| Sample | (Chitosan in acetic acid) | (Chitosan in lactic acid) |
| Log reduction | 0.90 | 3.20 |
| Percent reduction | 88.1% | 99.93% |
| Activity level | Low | Strong |

Sample 4 presents strong antimicrobial effect, whereas sample 2 has little to no antimicrobial effect.

Lactic acid clearly shows advantages over the use of acetic acid in achieving antimicrobial activity on the fabric.

### Conclusions on Further Experiments

The relative properties of the chitosan solutions prepared with either acetic acid or lactic acid are compared below:

| | | Chitosan in | Chitosan in |
|---|---|---|---|
| Property | Relevance to industrial use | acetic acid | lactic acid |
| Stability | Consistent properties | ++ | +++ |
| | (including viscosity) in | | |
| | storage is needed for useful | | |
| | product quality and | | |
| | lifetime. | | |
| Odor | Products that exhibit smell | + | ++++ |
| | are problematic in industrial | | |
| | production facilities. | | |
| | Products without odor are | | |
| | preferred. | | |
| Color | Colour of the product can | + | +++ |
| | contribute to discoloration | | |
| | (yellowing) of the treated | | |
| | textile. | | |
| Antimicrobial | Antimicrobial properties are | + | ++++ |
| activity | desirable for many textile | | |
| | applications where the | | |
| | functionality is to be used. | | |

Key:
+ = Poor . . .
++++ = very good

Stability: Stability of the lactic and acetic acid preparations are consistent during storage at room temperature and 40° C. At extreme conditions of 60° C., the viscosity reduction during storage is much more evident for preparations with acetic acid where viscosity reduction is consistently more than 50%.

Odor: Lactic acid leads to a solution without odor while acetic acid gives a strong odor.

Color: Lactic acid preparation shows significantly less color than for acetic acid.

Antimicrobial activity: lactic acid presents strong antimicrobial effect, while acetic acid has low effect level.

Preparation of chitosan solutions using lactic acid therefore clearly shows advantages over the use of acetic acid.

1. Method for producing a microparticulate emulsion or dispersion for textile treatment and for, on said textile, forming, at least in areas thereof, a porous film carrying an active, wherein the method comprises the following steps in given order:
a) mixing
a chitosan solution essentially consisting of chitosan in aqueous lactic acid with an emulsion, dispersion, suspension or solution of the active in a hydrophobic solvent
under formation of an emulsion,
b) adding, if required, further lactic acid to said emulsion for reducing the pH to a value in the range of 3-4.2 and for initiating coacervation of said emulsion,
c) adding a cross-linking agent for cross-linking of the droplets and/or particles in the emulsion or dispersion.

2. Method according to claim 1, wherein the chitosan in the chitosan solution used in step a) has a molecular weight in the range of 200-500 g/mol,
and/or wherein the chitosan in the chitosan solution used in step a) has a degree of the deacetylation in the range of 90-99%,
and/or wherein the chitosan is present in the chitosan solution in step a) in a concentration in the range of 4-10% % w/w,
and/or wherein lactic acid is present in the chitosan solution used in step a) in a concentration in the range of 1.5-5% w/w,
and/or wherein the pH of the solution used in step a) is in the range of 3-5,
and/or wherein the chitosan solution used in step a) has a viscosity in the range of 1500-3500 cP, measured at 25° C.,
and/or wherein the chitosan solution used in step a) further comprises a stabiliser, in an amount of less than 0.5% w/w,
and/or wherein the chitosan is based on crustacean waste material.

3. Method according to claim 1, wherein at least one of steps a)-c), or all steps a)-c), are carried out at a temperature in the range of 15-30° C.

4. Method according to claim 1, wherein in step a) before joining the chitosan solution and the active an emulsifier is added.

5. Method according to claim 1, wherein the active is dissolved or suspended in at least one natural oil
and/or wherein the active is present in a natural oil in a proportion of 5-60% w/w.

6. Method according to claim 1, wherein in step a) the chitosan solution is added to the emulsion, suspension, dispersion or solution of the active in a hydrophobic solvent such that in the joined emulsion, the emulsion, suspension, dispersion or solution of the active in a hydrophobic solvent is present in a proportion of 1-12% w/w.

7. Method according to claim 1, wherein the active is selected from the group consisting of microorganisms, essential oils, fragrances, vitamins, prebiotics, or a combination thereof, wherein in case of microorganisms these microorganisms are carried in at least one of a carrier and nutrients,
and/or wherein the active is a dormant and/or non-pathogenic microorganism,
and/or wherein the essential oils and/or vitamins are selected from the group of bergamot oil, lavender oil, peppermint oil, cedarwood oil, citronella oil, cardamon oil, cinnamon bark oil, clove oil, eucalyptus oil, geranium oil, ginger oil, lemon myrtle oil, lemongrass oil, rosemary oil, sandalwood oil, spearmint oil, tea tree oil, thyme oil, rose oil, orange oil, grapefruit oil, chamomile oil, wintergreen oil, vitamin A, Vitamin B3, vitamin B5, vitamin C, vitamin D, vitamin E, vitamin K, or a combination thereof.

8. Method according to claim 1, wherein the droplets and/or particles in the emulsion or dispersion obtained in step c) have diameters in the range of 0.2-3 micro metre,
and/or wherein the droplets and/or particles in the emulsion or dispersion obtained in step c) consist of porous microparticles of the active embedded in a porous film of cross-linked chitosan.

9. Method according to claim 1, wherein in step c) a cross-linking agent selected from the group consisting of tannic acid, humic acid, gallic acid, genipin, sinapinic acid, or a combination thereof, is added as a cross-linking agent,
and/or wherein in step c) a cross-linking agent preferably tannic acid, is added in a proportion, with respect to the total to which the cross-linking agent is added, in the range of 0.001-0.1% w/w.

10. Method according to claim 1 wherein subsequent to step c), the porous microparticles obtained are formulated into a textile treatment system, or a concentrate of such a system.

11. Method according to claim 10, wherein the textile treatment system is applied to fibers, yarn, or woven or nonwoven textiles.

12. Textile treatment system, on an aqueous dispersion, emulsion or solution basis, obtainable or obtained using a method according to claim 11.

13. Fiber, yarn or woven or nonwoven textile treated with a textile treatment system according to claim 12, wherein preferably at least in areas there is a film of porous chitosan with embedded porous microparticles of the active.

14. Clothing, household textile, including furniture textiles based on a fiber, yarn, or woven or nonwoven textile according to claim 13.

15. Method of using porous microparticles obtained using a method according to claim 1 for antibacterial and/or antiviral and/or anti-allergenic treatment of fibers, yarns or woven or nonwoven textile, including for clothing, household textiles, including furniture textiles.

16. Method according to claim 1, where the active is for antibacterial, antiviral and/or anti-allergenic textile treatment

17. Method according to claim 1, wherein the chitosan in the chitosan solution used in step a) has a molecular weight in the range of 200-350 g/mol, or in the range of 250-300 g/mol,
and/or wherein the chitosan in the chitosan solution used in step a) has a degree of the deacetylation in the range of 92-97%,
and/or wherein the chitosan is present in the chitosan solution in step a) in a concentration in the range of 5-8% w/w, or in the range of 4-7% w/w,
and/or wherein lactic acid is present in the chitosan solution used in step a) in a concentration in the range of 2-4.5% w/w, or in the range of 34% w/w,
and/or wherein the pH of the solution used in step a) is in the range of 3.5-4.2,
and/or wherein the chitosan solution used in step a) has a viscosity in the range of 2000-3000 cP, measured at 25° C.,
and/or wherein the chitosan solution used in step a) further comprises a stabiliser, in the form of at least one of zinc chloride and sodium sulphite, in an amount of less than 0.5% w/w, or of less than 0.3% w/w or less than 0.25% w/w.

18. Method according to claim 1, wherein all steps a)-c), are carried out at a temperature in the range of 15-30° C., or in the range of 18-25° C.

19. Method according to claim 1, wherein in step a) before joining the chitosan solution and the active an emulsifier is added to the chitosan solution, wherein the emulsifier is an emulsifier based on glycerol and fatty acids, including those selected as polyglycerol polyricinoleate, glycerol monooleate, glyceryl dicaprylate, glyceryl dimyristate, glyceryl dioleate, glyceryl distearate, glyceryl monomyristate, glyceryl monooctanoate, glyceryl monooleate, glyceryl monostearate, glyceryl stearate, lecithin, polyglyceryl oleate, polyglyceryl stearate, tetraglyceryl monooleate, or a combination thereof, in a concentration, based on the weight of the chitosan solution and the emulsifier, in the range of 0.4-4% w/w, or in the range of 0.5-3% w/w, or in the range of 0.6-2.5% w/w.

20. Method according to claim 1, wherein the active is dissolved or suspended in at least one natural oil, selected from the group consisting of oat oil, castor oil, coconut oil, almond oil, cod-liver oil, fish oil, cottonseed oil, rapeseed oil, soybean oil, linseed oil, palm oil, wheat germ oil, rice bran oil, olive oil, avocado oil, argan oil, blueberry seed oil, carrot seed oil, hazelnut oil, jojoba oil, quinoa oil, sesame oil, walnut oil, algae oil, acai oil, shea butter, mango butter, cocoa butter, or hydrogenated oils made therefrom, or a combination thereof,
and/or wherein the active is present in the natural oil in a proportion of 10-50% w/w.

21. Method according to claim 1, wherein in step a) the chitosan solution is added to the emulsion, suspension, dispersion or solution of the active in a hydrophobic solvent such that in the joined emulsion, the emulsion, suspension, dispersion or solution of the active in a hydrophobic solvent is present in the range of 2-9% w/w.

22. Method according to claim 1, wherein the active is selected from the group consisting of microorganisms, essential oils, fragrances, vitamins, prebiotics, or a combination thereof, wherein in case of microorganisms these microorganisms are carried in at least one of a carrier and nutrients, namely in at least one of calcium carbonate and carbohydrates, including prebiotics, wherein the calcium carbonate and/or carbohydrates, including prebiotics make up at least 90% w/w and the microorganisms make up at most 10% w/w,
and/or wherein the active is dormant and/or non-pathogenic microorganism, or a mixture of different such microorganisms, selected from the group consisting of Subtilis, Pumilus, Megaterium, Licheniformis, Amyloliquefaciens, Cereus, Anthracis, Licheniformis, Larvae, Lentimorbus, Popilliae, Sphaericus, Thuringiensis, Alvei, Brevis, Circulans, Coagulans, Macerans, or a combination thereof, and prebiotics can be selected and added to the formulation from a group of fructans and galactans, inulin, beta-glucan, soybean oligosaccharides, pectin and pectin-derived oligosaccharides, cocoa-derived flavanols, fructooligosaccarides.

23. Method according to claim 1, wherein the droplets and/or particles in the emulsion or dispersion obtained in step c) have diameters in the range of 0.7-2.5 micro metre.

24. Method according to claim 1, wherein in in step c) a cross-linking agent in the form of tannic acid, is added in a proportion, with respect to the total to which the cross-linking agent, in the range of 0.001-0.1% w/w, or in the range of 0.005-0.07% w/w.

25. Method according to claim 1, wherein subsequent to step c), the porous microparticles obtained are, after drying, formulated into a textile treatment system, or a concentrate of such a system, wherein that system is based on water only in addition to the dispersion obtained in step c).

26. Method according to claim 10, wherein the textile treatment system is applied to fibers, yarn, or woven or nonwoven textiles, which are further converted into clothing, household textiles, including furniture textiles, wherein the textile treatment system is added in a proportion of 3-15% weight of fabric, or in a proportion of 6-10% weight of fabric.

27. Fiber according to claim 13, wherein at least in areas there is a film of porous chitosan with embedded porous microparticles of the active.

28. Method according to claim 15 for antibacterial and/or antiviral and/or anti-allergenic treatment of fibers, yarns or woven or nonwoven textile, namely for clothing, household textiles, including furniture textiles.
